(19) United States
(12) Patent Application Publication
(10) Pub. No.: US 2007/0171021 A1
(43) Pub. Date: Jul. 26, 2007

(54) Transformer winding and production method thereof

(76) Inventors: Jean-Marc Scherrer, Riedisheim (FR); Jean-Paul Scherrer, Mulhouse (FR); Jean-Claude Beisser, l'Argentiere La Bessee (FR)

Correspondence Address: YOUNG & THOMPSON, 745 SOUTH 23RD STREET, 2ND FLOOR, ARLINGTON, VA, 22202, US

(21) Appl. No.: 10/553,658

(22) PCT Filed: May 14, 2004
(86) PCT No.: PCT/FR04/01198

§ 371 Date: Oct. 17, 2006

(30) Foreign Application Priority Data
May 16, 2003 (FR) 03/05917

(51) Int. Cl. H01F 5/00

(52) U.S. Cl. 336/200; 336/208

(57) ABSTRACT

The invention relates to a method of producing a winding (1), e.g. for an electrical transformer, from a cylindrical, tubular metal element having a straight polygonal section. The inventive method is characterized in that it comprises the following steps consisting in: machining a series of essentially-parallel cuts through all of the sides (1a, 1c, 1d) of the tubular element excluding one last side (1b), said step being performed in a first series of passes; and, in a second series of passes, machining cuts in the aforementioned last side (1b) in order to form a junction with the cuts in the adjoining sides, such that said cuts are continuous and form a single helicoidal groove.

The present invention relates to a winding for electrical transformer and in particular a low-voltage, high-intensity secondary winding therefor, as well as to a method for producing such a winding.

The manufacture of transformers able to deliver values of high intensity is often difficult by reason of the necessity to coil, particularly at the level of the secondary winding, wires of large diameter. Furthermore, in such transformers, it is particularly difficult to arrange on these windings points, such as middle points, making it possible to establish an output in communication with a determined number of turns thus allowing variable output voltages to be drawn off. Moreover, it is known that transformers of this type, probably by reason of the difficulties mentioned hereinbefore, are of particularly high cost price.

U.S. Pat. No. 3,731,243 proposes a method of producing a winding for electrical transformer in which a cylindrical tubular element of square cross-section is taken and machined by means of a circular saw with which inclined grooves are successively made on each of the faces of this cylindrical element, which grooves join one another from one side to the other so as to form a helicoidal turn. This technique presents the drawback of being long and complex to implement insofar as parallel and inclined grooves must be made on each of the faces of the tubular element.

The present invention has for its object to overcome the various drawbacks mentioned above by presenting a winding for transformer, and in particular a low-voltage, high-intensity secondary winding, which is machined in the mass of a tubular element and which is easy to implement, and therefore of relatively moderate manufacturing cost and which, moreover, presents voltage tapping points disposed on virtually any number of turns, thus allowing the user to have available a voltage, particularly output voltage, which is totally adaptable as a function of his needs.

The present invention thus relates to a method for producing a winding, particularly for electrical transformer from a cylindrical tubular metal element of polygonal cross-section, characterized in that it comprises the steps consisting in:

machining, in a first series of passes, a series of cuts substantially parallel to one another through all of the sides of the tubular element with the exception of a last side,

machining, in a second series of passes, cuts in said last side in order to ensure junction of the cuts opening out in the sides adjacent the latter, so that these cuts are continuous with respect to one another and constitute a single groove of helicoidal shape.

Machining of the cuts will preferably be effected by means of a rotary machining disc.

The present invention also has for its object a winding, particularly for electrical transformer, constituted by a cylindrical tubular metal element of polygonal cross-section, hollowed so as to form a helix, characterized in that at least one of the sides of the cylindrical tubular element comprises grooves which extend along a generatrix thereof, which are open on the outside and which have a cross-section in the form of a T, each of these grooves being adapted to receive means for fastening an electrical terminal. The cross-section of the tubular element will preferably be square, rectangular or triangular in shape.

A form of embodiment of the present invention will be described hereinafter by way of non-limiting example, with reference to the accompanying drawing, in which:

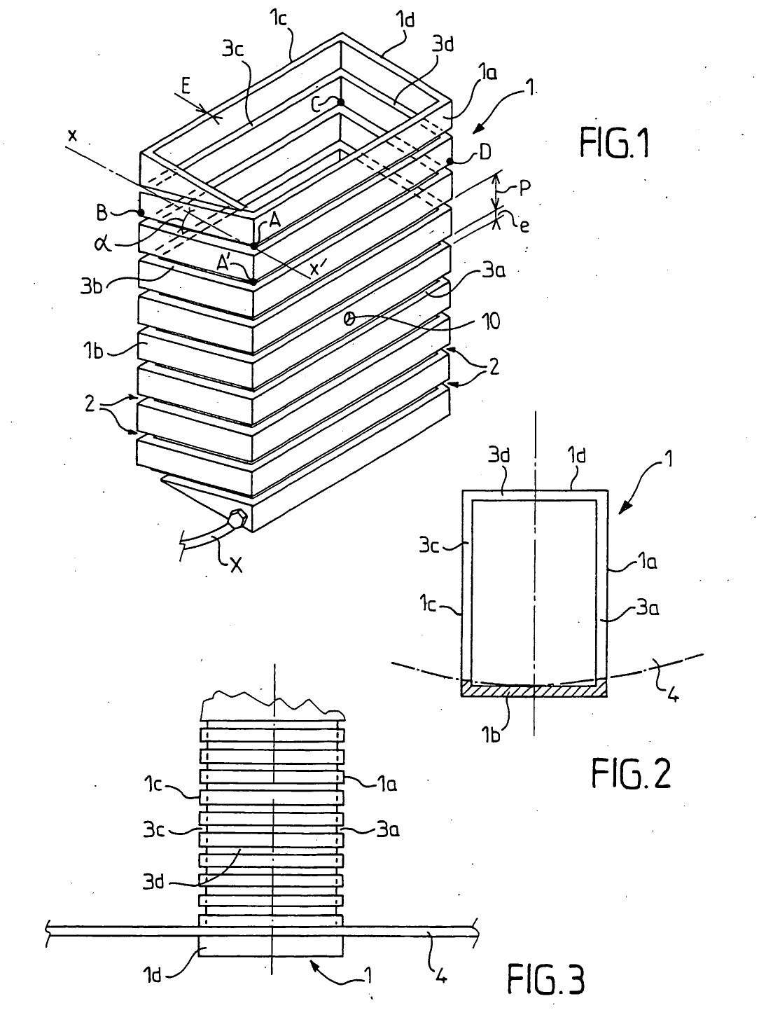

FIG. 1 is a view in perspective of a form of embodiment of a winding of a transformer according to the invention.

FIG. 2 is a view in vertical section of the tubular element and of the rotating tool during the first machining pass.

FIG. 3 is a plan view from above of the tubular element and of the machining tool shown in FIG. 2.

FIG. 4 is a view in vertical section of the tubular element and of the rotating tool in the course of the second machining pass.

FIG. 5 is a plan view from above of the tubular element and of the machining tool shown in FIG. 4.

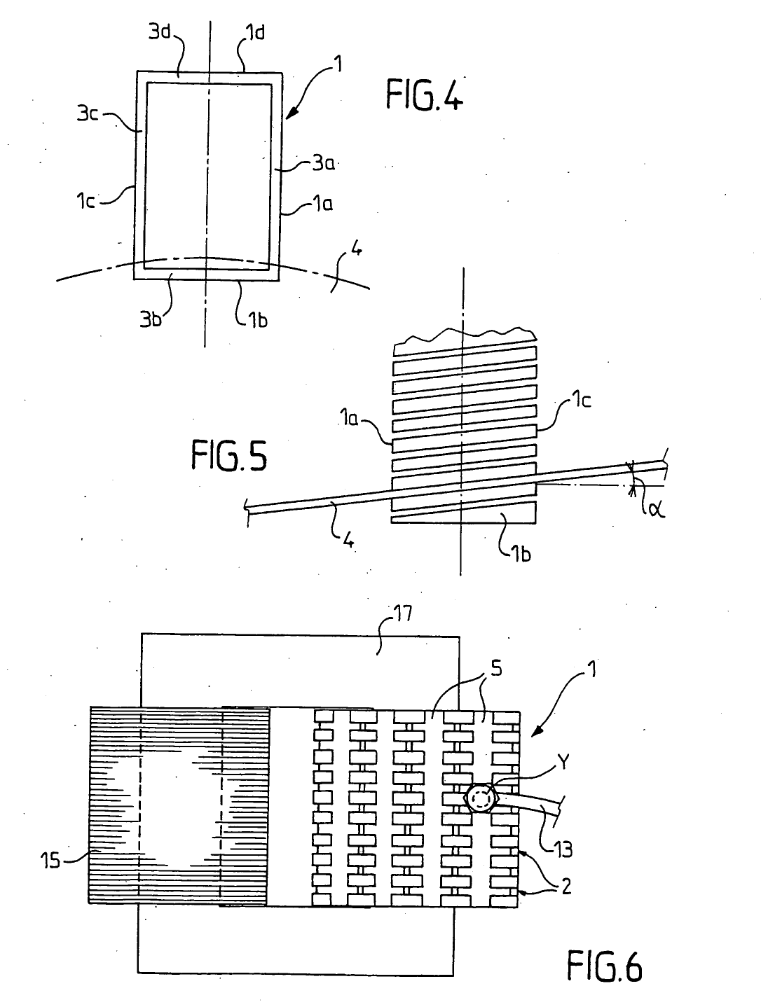

FIG. 6 is a schematic front view of an example of transformer equipped with a winding according to the invention.

FIG. 7 is a plan view from above of the transformer shown in FIG. 6.

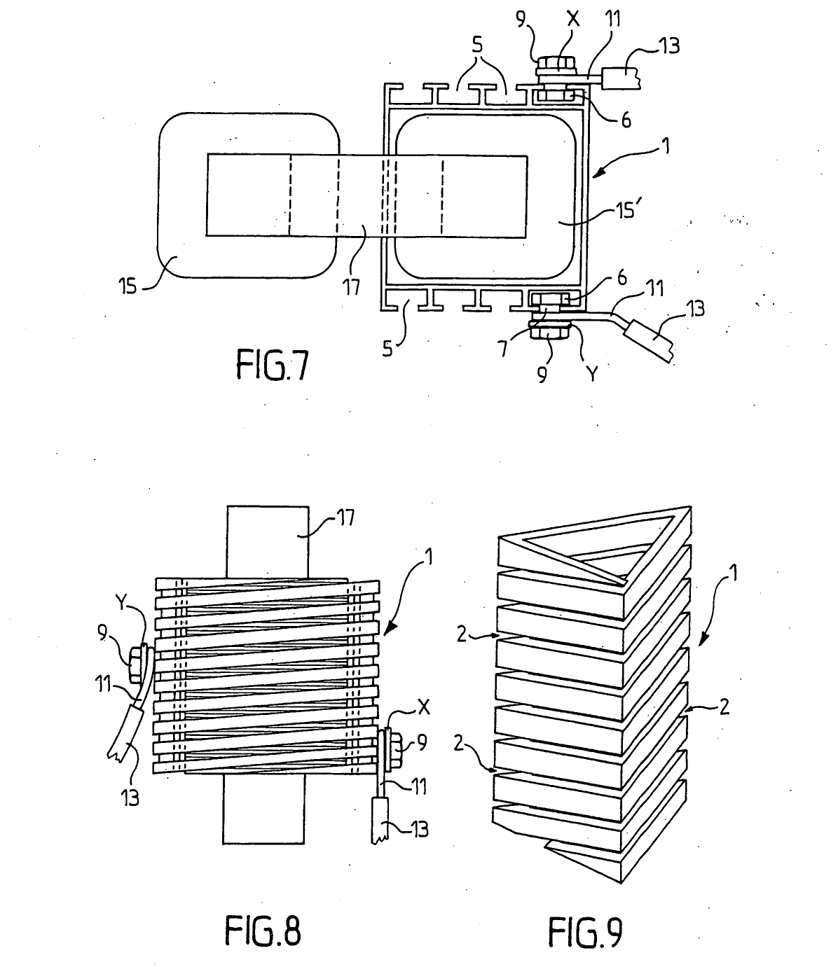

FIG. 8 is a side view of the transformer shown in FIGS. 6 and 7.

FIG. 9 is a view in perspective of a variant embodiment of the present invention.

FIG. 1 shows in perspective a winding 1 according to the invention intended to constitute in particular the secondary winding of a transformer. This secondary winding 1 is constituted by a cylindrical tubular element of rectangular cross-section, thus comprising four principal faces 1a, 1b, 1c, 1d. This tubular element has a slot 2 made therein, of substantially helicoidal shape, which passes right through its thickness and which extends over the whole of its periphery from its apex to its base.

This slot 2 is in fact constituted by a series of rectilinear and parallel windows 3a, 3b, 3c, 3d which are machined from one of the four faces, namely here from the face 1d. As shown in FIGS. 1 to 5, the windows 3a, 3c and 3d are transversal and are machined in one single series of passes with the aid of a rotating machining disc 4 from the face 1d as shown in FIGS. 2 and 3, while the windows 3b are made during a second series of passes through the face 1b and are inclined by an angle a with respect to their transverse axis xx′, so that they ensure the connection with the corresponding grooves 3a and 3c of the faces 1a and 1c which are adjacent thereto so as to form a substantially helicoidal slot 2, and that, when one turns around the tubular element 1, starting for example from an angle A thereof and passing through respective angles B, C and D, one arrives at point A′, located beneath point A, at a distance therefrom equal to the sum of the inter-slot space, or pitch P, separating the different slots, and of the width e of the slot 2.

A helicoidal slot made in the profiled element 1 is thus definitively obtained.

This form of embodiment is particularly interesting in that it may be implemented very easily, rapidly and repetitively by numerically controlled machines which, for example, will make all the transverse parallel grooves from the face 1d of the tube, then, after turning of the latter and a slight inclination α, will make the grooves 3b inclined by an angle α with respect to the transverse axis xx′.

Such a form of embodiment thus proves to be particularly easy, rapid and inexpensive to carry out in comparison, on the one hand, with the coiled embodiments of the prior state of the art requiring the use of windings constituted by wires of very large section, and, on the other hand, with the embodiment according to U.S. Pat. No. 3,731,243 which requires as many series 20 of passes as there are faces of the cylindrical tube.

In the present form of embodiment, the cross-section of the winding may be easily controlled by playing on the thickness e of the wall of the tubular element 1, and also on the value of the pitch P thereof.

The present invention is also particularly interesting in that it makes it possible to have easily available a middle point on such a winding by making, s for example as shown in FIG. 1, a simple threaded hole 10 in an inter-slot space on which it will be easy to fasten, by appropriate screwing means, an output terminal, on a conducting wire. The user may thus select, between this output terminal and a reference terminal X, virtually any secondary voltage included between 0 and the output voltage provided for the transformer.

FIGS. 6 to 8 show a particularly interesting variant of the invention in which the tubular element is constituted by a profiled element whose cross-section, which clearly appears in FIG. 7, is of square shape, two opposite sides of the profiled element 1 comprising grooves 5 extending along a generatrix of the profile, which are open on the outside and have a cross-section in the form of a T. Each of these grooves 5 is thus adapted to receive the head 6 of a screw 7 making it possible, by means of a nut 9, to ensure the fastening of an electrical terminal 11 on which is welded a conducting wire 13. As shown in FIG. 7, the transformer may be constituted by a first outer primary coil 15, and by a second primary coil 15′ which is disposed inside the secondary winding 1, which are connected together, in conventional manner, by a magnetic circuit 17. As in the preceding example, the secondary winding 1 of this transformer is made by machining of a type such as the one described with regard to FIG. 1. The present form of embodiment is particularly interesting in that it allows the user to have available, between a terminal X taken as reference of the secondary winding and a second terminal Y, a voltage proportional to the number of turns existing between these two terminals. In effect, the T-shaped grooves 5 make it possible to have available the means for connection of the terminal Y in virtually any zone of the two opposite faces 1a and 1b.

According to the invention, the cross-section of the tubular element may, of course, be of any shape. It may thus, as shown in FIG. 9, be of triangular cross-section or of polygonal cross-section, and this as a function of the specific uses desired by the user.

For example, in the case of a tubular element of polygonal section with n sides, a first series of passes machining n-1 sides will be effected. These passes preferably being transverse with respect to the tubular element, then a second series of passes on the remaining side of which the inclination a will allow slots of the adjacent sides to be joined so as to form a helicoidal machining.

1. Method for producing a winding, particularly for electrical transformer from a cylindrical tubular metal element of polygonal cross-section, characterized in that it comprises the steps consisting in:
machining, in a first series of passes, a series of cuts substantially parallel to one another through all of the sides (1a, 1c, 1d) of the tubular element with the exception of a last side (1b),
machining, in a second series of passes, cuts in said last side (1b) in order to ensure junction of the cuts opening out in the sides adjacent the latter, so that these cuts are continuous with respect to one another and constitute a single groove of helicoidal shape.

2. Method according to claim 1, characterized in that machining of the cuts is ensured by means of a rotary machining disc.

3. Winding, particularly for electrical transformer, constituted by a cylindrical tubular metal element of polygonal cross-section, hollowed so as to form a helix, characterized in that at least one of the sides of the cylindrical tubular element comprises grooves which extend along a generatrix thereof, which are open on the outside and which have a cross-section in the form of a T, each of these grooves being adapted to receive means for fastening an electrical terminal.

4. Winding according to claim 3, characterized in that the cross-section of the tubular element is square, rectangular or triangular in shape.
